(19) United States
(12) Patent Application Publication
(10) Pub. No.: US 2008/0106791 A1
(43) Pub. Date: May 8, 2008

(54) TRANSMISSION TYPE DIFFRACTION GRATING

(75) Inventors: Naoko Hikichi, Tokyo (JP); Kenichi Nakama, Tokyo (JP)

Correspondence Address: DARBY & DARBY P.C., P.O. BOX 770, Church Street Station, New York, NY, 10008-0770, US

(73) Assignee: Nippon Sheet Glass Co., Ltd., Tokyo (JP)

(21) Appl. No.: 11/943,869

(22) Filed: Nov. 21, 2007

Related U.S. Application Data
(63) Continuation-in-part of application No. 11/078,650, filed on Mar. 11, 2005.

(30) Foreign Application Priority Data
Mar. 11, 2004 (JP) 2004-069269

(51) Int. Cl. G02B 5/18

(52) U.S. Cl. 359/576; 359/569

(57) ABSTRACT

A transmission grating that provides low polarization dependent loss over a wide wave range and provides high diffraction efficiency even with a small groove pitch and high resolving power and dispersion.

In a transmission grating 10, multiple parallel ridges 22 that are transparent for the wave range to be used are disposed on one side of a substrate 20 that is transparent for the wave range to be used. Parallel grooves 24 are formed at a fixed pitch a between these ridges. Light is applied from the surface of the transmission grating on which the grooves are formed and diffracted light is extracted from the substrate surface on which grooves are not formed. The groove pitch a is set to a range of 0.51 λc-1.48 λc, where λc is the central wavelength.

### INCORPORATION BY REFERENCE

This application is a continuation-in-part of U.S. application Ser. No. 11/078,650, filed Mar. 11, 2005, titled “Transmission Type Diffraction Grating” and claims priority under 35 U.S.C. §119 to Japanese Patent Application No. 2004-069269 filed on Mar. 11, 2004. The content of these applications are incorporated herein by reference in their entirety, as is all amendments filed in application Ser. No. 11/078,650.

### FIELD OF THE INVENTION

The present invention relates to a transmission grating used in spectrum analysis, optical measurement, optical communication, and the like.

### BACKGROUND OF THE INVENTION

In a diffraction grating with a groove count N per unit width and a width W, a resolving power λ/Δλ of this diffraction grating can be expressed as follows, where the m-th order diffraction of a light with a wavelength λ has an angle of diffraction of θ:
λ/Δλ=mNW

Also, the angular dispersion Δθ′/Δλ is expressed as follows.
Δθ′/Δλ=mN/cos θ′

Higher resolving power and angular dispersion improves the precision and sensitivity of the analyzer or measurement device. Also, the optical system can be made more compact. For this reason, it would be preferable for the diffraction grating to provide a high resolving power and angular dispersion.

Based on the above equations, the resolving power and the angular dispersion can be increased by using a diffracted light with a high order of diffraction m or by increasing the number of grooves in the diffraction grating.

However, the use of diffracted light with a higher order of diffraction generally results in less diffraction efficiency compared to diffracted light with lower orders. In particular, this tendency is especially prominent in standard transmission gratings. As a result, in such cases an order of diffraction of +/−1 is almost always used.

Furthermore, when a high-order diffracted light is used, range limitations result from the free spectral range. When diffracted light with an order of diffraction of m is used from wavelengths λ to λ′, the following condition must be met to prevent overlapping of diffracted light:
λ′−λ<=λ/m (λ<λ′)

This range restriction is a significant problem for use of diffraction gratings with multiple wavelengths or wide wavelength ranges. This range restriction can be avoided by using filters or multiple detectors or the like (e.g., see Non-patent Document 1), but these measures led to problems such as light energy loss and increased complexity in structure. Thus, the increasing of the number of grooves is a simpler and more effective method for increasing resolving power and dispersion.

[Non-patent Document 1] “Butsuri Kougaku” (Physical Optics), Yasuo Yoshiwara, Kyouritsu Shuppan Corp. Ltd., 1966, p. 111.

However, it is known that increasing resolving power and dispersion by increasing the number of grooves and decreasing the groove pitch can lead to a tendency to make diffraction efficiency dependent on polarization or reduce energy efficiency. Also, reliably obtaining high diffraction efficiency at over wide wavelength ranges becomes more difficult. These tendencies are especially prominent when a groove pitch a is about the same as the wavelength λ or the groove pitch a is less than the wavelength λ.

### OBJECT AND SUMMARY OF THE INVENTION

The object of the present invention is to overcome these problems and to provide a transmission grating that can provide high diffraction efficiency and low polarization dependent loss over a wide wavelength range even when the groove pitch is small and resolving power and dispersion are high.

The present invention relates to a transmission grating wherein: a plurality of parallel ridges that are transparent at a wavelength range to be used is disposed at a fixed pitch on one surface of a substrate that is transparent at the wavelength range to be used; and parallel grooves are formed between the ridges. When light is applied to the surface on which the grooves of the transmission grating are formed and diffracted light is obtained from a substrate surface on which the grooves are not formed, a groove pitch a is in a range of 0.51 λc-2.16 λc, where λc is a center wavelength of the wavelength range to be used. It would be preferable for the groove pitch a is in a range 0.51 λc-1.48 λc, and it would especially preferable for the range to be 0.51 λc-1.1 λc.

If the groove pitch a is 1.48 λc, +2 order light and −2 order light is not generated even if light with a wavelength of λc-0.013 λc is applied at an angle of incidence for which the center wavelength λc meets the Bragg condition. As a result, a high diffraction efficiency can be provided for +/−1 order diffracted light for the wavelength range to be used.

The shorter the groove pitch a is from 1.48 λc, the less +2 order light and −2 order light tends to be generated, so this is preferable. In particular, a groove pitch of no more than 1.1 λc will provide high dispersion, making this more preferable.

With transmission gratings, high dispersion can result in the diffraction angle causing total internal reflection at the boundary surface between the substrate and the emergence-side medium, preventing the diffracted light from exiting the substrate. For this reason, it would be preferable to have the groove pitch a be at least 0.51 λc. This allows diffracted light to be obtained for the wavelength range to be used without leading to obstruction caused by total internal reflection.

It would be preferable for an average index of refraction of a diffraction grating region formed from the ridges and the grooves to be in a range of approximately 1.02 to 1.16, or greater than 1.26.

If the average index of refraction is 1.02 or greater, the polarization dependence of the diffraction is reduced. If n is 1.8 or less, high diffraction efficiency can be obtained.

It would be preferable for an index of refraction N of the ridges and a ratio D=d/a of a groove width d and a groove pitch a to be within a range defined by points (D, N) indicated below on a D-N plane coordinate system where N is a longitudinal axis and D is a lateral axis:

(0.30, 1.87), (0.30, 2.30), (0.62, 2.30),

(0.70, 2.14), (0.70, 1.37), (0.50, 1.52)

(0.40, 1.65)

The relationship between D and N is expressed as follows:
(N−1)×D=n−1

It would be preferable here to have n be in the range of approximately 1.02 to 1.16, or greater than 1.26 as described above. In the actual production of diffraction gratings, it would be preferable for D to be in the range 0.3-0.8. Also, since N is generally 2.3 or less, this results in the above range. More specifically, with the above range, a diffraction grating with superior characteristics can be easily produced.

It would be preferable for the ridges to be formed from a plurality of materials. By combining multiple materials, the average index of refraction n of the periodic structure can be adjusted without being restricted to material-specific indices of refraction.

It would be preferable for the depth h of the grooves to be in a range 0.8 λc-8.0 λc with regard to the center wavelength λc of the wavelength range to be used. A groove depth of less than 0.8 λc will prevent high diffraction efficiency, while a depth of more than 8.0 λc will prevent uniform optical characteristics over a wide wavelength range.

It would be preferable for an aspect ratio h/d defined as a ratio of the groove depth h and a groove width d to be no more than 6.8. From the point of view of the production process for the diffraction grating grooves, a shallower groove depth is preferable. With an aspect ratio of 6.8 or less, the optical characteristics described above can be maintained while the processing of grooves can be made easier.

With the structure of the present invention, a transmission grating can be provided that offers high resolving power and angular dispersion while offering high diffraction efficiency over a wide wavelength range and low polarization dependent loss.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a simplified cross-section drawing of the basic structure of a transmission grating according to the present invention.

FIG. 2 shows an example of the relationship between diffraction efficiency and polarization-dependent loss in a transmission grating and wavelength.

FIG. 3 shows another example of the relationship between diffraction efficiency and polarization-dependent loss in a transmission grating and wavelength.

FIG. 4 shows another example of the relationship between diffraction efficiency and polarization-dependent loss in a transmission grating and wavelength.

FIG. 5 shows another example of the relationship between diffraction efficiency and polarization-dependent loss in a transmission grating and wavelength.

FIGS. 6a and 6b show comparative examples of the relationship between diffraction efficiency and polarization-dependent loss in a transmission grating and wavelength.

FIG. 7 is a drawing showing the relationship between the diffraction efficiency in a transmission grating according to the present invention and the angle of incidence.

FIG. 8 is a drawing showing the relationship between cut-off wavelength and angular dispersion in a transmission grating according to the present invention and groove pitch.

FIGS. 9a and 9b are drawings for the purpose of describing the average index of refraction in a periodic structure in a transmission grating according to the present invention.

FIG. 10 is drawing showing the relationship between the duty cycle and the index of refraction of ridges in a transmission grating according to the present invention.

FIGS. 11a and 11b are simplified cross-section drawings of a transmission grating according to the present invention where ridges are formed from multiple materials.

FIG. 12 is a drawing showing the relationship between groove depth and bandwidth in a transmission grating according to the present invention.

FIG. 13 is a drawing showing the relationship between aspect ratio and bandwidth in a transmission grating according to the present invention.

### LIST OF DESIGNATORS

10: transmission grating
20: substrate
22: ridge
24: groove

### DETAILED DESCRIPTION OF THE PREFERRED EMBODIMENTS

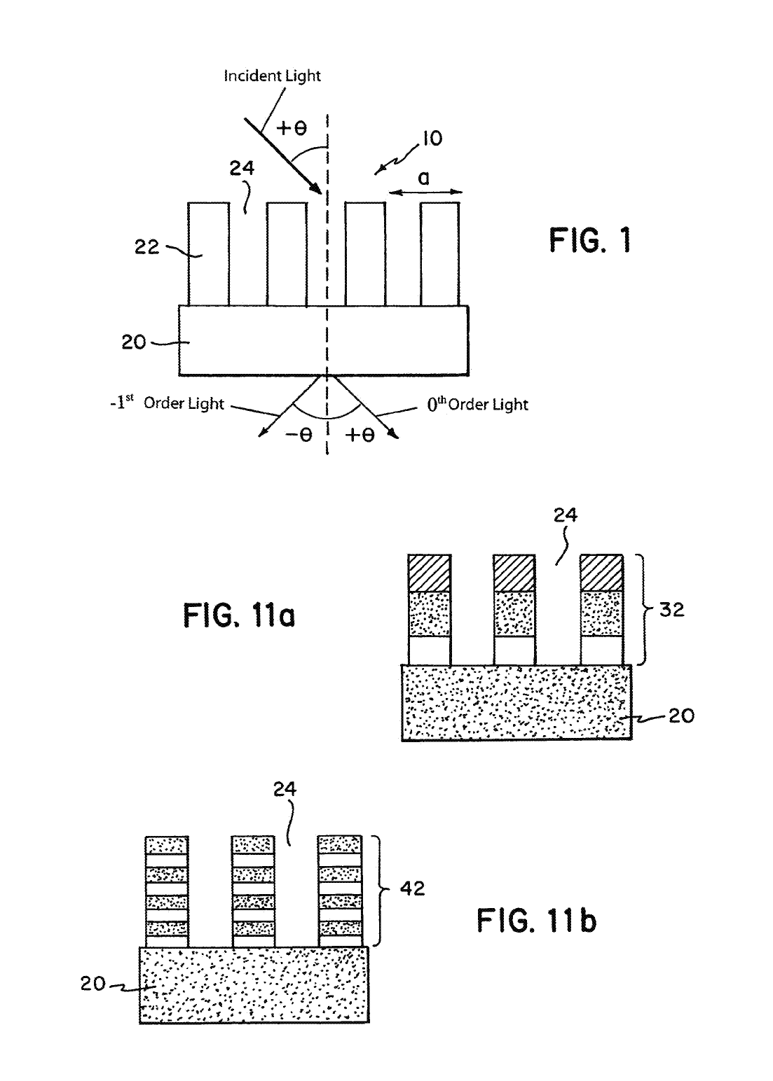

FIG. 1 shows a simplified cross-section view of a transmission grating 10 according to the present invention. Multiple ridges 22 and grooves 24 are alternated with a fixed pitch a, forming a periodic structure disposed on one face of a flat substrate 20. This diffraction grating is transmissive, so the structure must be formed from a material that is transparent at least the wavelength region that will be used.

In the transmission grating of the present invention, light is applied from the face on which the periodic structure is formed and diffracted light is obtained from the face of the substrate on which the periodic structure is not formed. Also, the structure is used in a system where +1 diffraction order light or −1 diffraction order light is handled as a signal. The labeling on FIG. 1 shows just one example, and it would be possible to substitute +1 order for −1 order.

To obtain high diffraction efficiency, in the transmission grating of the present invention the diffraction order m, the groove pitch a, and the incident angle θ are set up to meet the Bragg condition shown below for the design center wavelength λ.
mλ=2a sin θ

A method for making the transmission grating presented above will be described.

The ridges can be formed by processing the transparent substrate itself, but it would also be possible to deposit a different transparent material on the transparent substrate to achieve a predetermined thickness and then process that material. A Cr film to be used as a mask during the etching process is then sputtered onto these surfaces. Then, photolithography and etching are used to form a striped etching mask by patterning the Cr film to provide the desired groove pitch and groove width.

Next, an inductively-coupled plasma reactive ion etching (ICP-RIE) device is used to perform vapor etching with the mask. This results in the predetermined rectangular structure. Besides glass and transparent resin, the transparent substrate and transparent material can be formed any standard material that can provide the desired index of refraction such as a dielectric used in optical films.

The cross-section shapes of the ridges and grooves can be anything as long as they are essentially rectangular. For example, the ridges can be trapezoids with somewhat different upper bases and lower bases. Also, the side surfaces of the ridges can be tilted slightly away from the perpendicular line relative to the substrate surface and can form fine irregularities and gradual curves that do not disperse light at the wavelength range being used. The upper base of the ridge and the bottom of the groove can be formed as spherical shapes. In particular, tapered ends of ridges do not greatly affect optical characteristics and can be tolerated.

Different types of material were used to produce multiple diffraction gratings with different groove pitches and widths according to the method above. The optical characteristics of these were then measured. Four examples will be described below. Descriptions of the other samples are omitted and the shapes and optical characteristics are summarized in Table 1.

### First Embodiment

Using the method described above, a transmission grating was formed from a quartz substrate (1.45 index of refraction at 1500 nm wavelength) with 939 grooves per mm, a proportion of groove width d relative to groove pitch a (duty cycle D=d/a) of 0.8, and rectangular grooves of 5.3 micron depth.

A center wavelength of λc=1500 nm was used for this diffraction grating, and light was applied at an incidence angle of 45 deg from the side with the diffraction grating. The diffraction efficiency was measured in a system where the 1500 nm light had a −1 order diffraction angle of −45 deg.

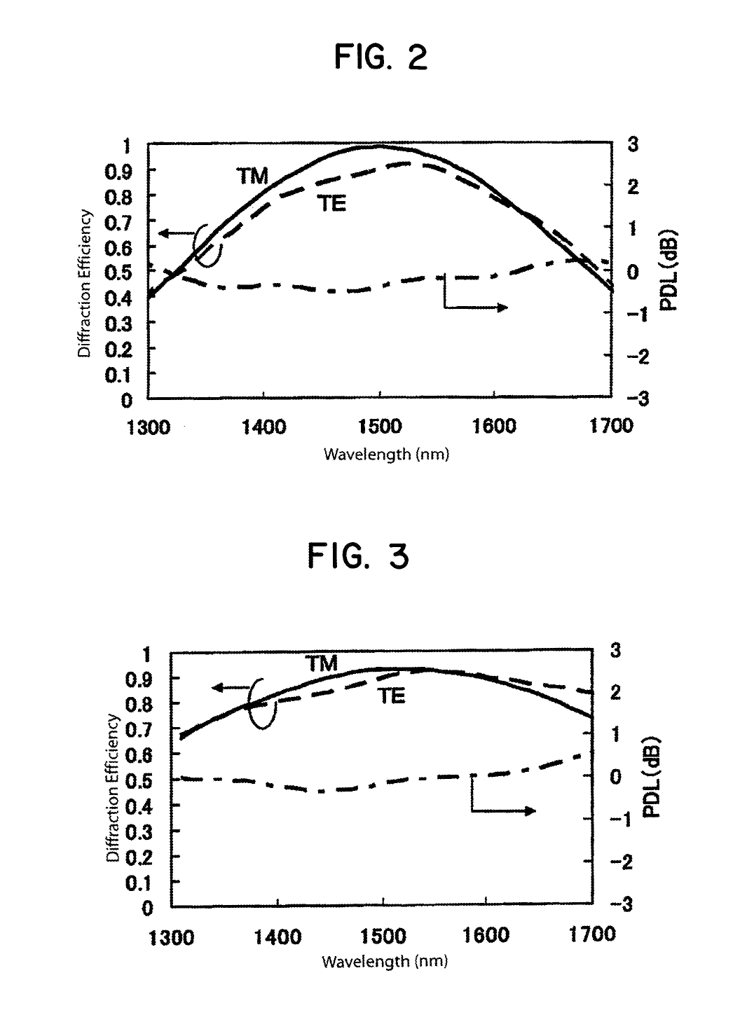

FIG. 2 shows diffraction efficiency and polarization dependent loss (PDL) as a factor of wavelength for TM mode and TE mode. Good characteristics were obtained, with TE mode and TM mode both resulting in at least 80% in the 1500+/−100 nm range, and a PDL of no more than +/−1 dB within the 1500+/−300 nm range.

### Second Embodiment

Using a method similar to that of the first embodiment, a transmission grating was formed from a quartz substrate with 800 grooves per mm, a duty cycle of 0.7, and rectangular grooves of 3.9 micron depth. A center wavelength of λc=1550 nm was used for this diffraction grating, and light was applied at an incidence angle of 38 deg from the side with the diffraction grating. The diffraction efficiency was measured in a system where the 1550 nm light had a −1 order diffraction angle of −38 deg. Good characteristics were obtained, as shown in FIG. 3, with the diffraction efficiency for both TE mode and TM mode being at least 80% in the 1550+/−140 nm range, and the PDL being no more than +/−1 dB in the 1550+/−250 nm range.

### Third Embodiment

A TiO₂ film was formed to a thickness of 1.4 micron on a quartz substrate. This TiO₂ film was processed to form a transmission grating with rectangular grooves, 900 grooves per mm, and a duty cycle of 0.5. The grooves were etched to remove all of the TiO₂ film, thus resulting in a groove depth of 1.4 micron identical to the thickness of the TiO₂ film.

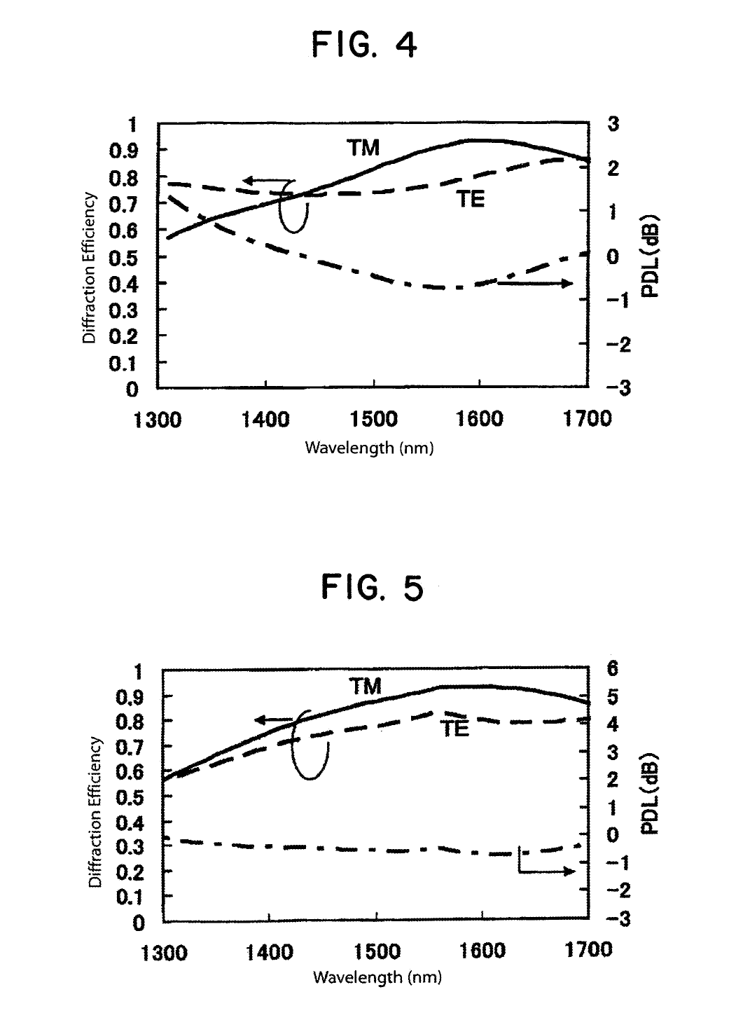

A center wavelength of λc=1550 nm was used for this diffraction grating, and light was applied at an incidence angle of 44 deg from the side with the diffraction grating. The diffraction efficiency was measured in a system where the 1550 nm light had a −1 order diffraction angle of −44 deg. Good characteristics were obtained, as shown in FIG. 4, with the diffraction efficiency for TE mode in a range of approximately 1500-1700 nm and TM mode in a range of approximately 1600-1800 nm being at least 80%, and the PDL being no more than +/−1 dB in the 1550+/−250 nm range.

### Fourth Embodiment

A Ta₂O₂ film was formed to a thickness of 1.4 micron on a quartz substrate. This Ta₂O₂ film was processed to form a transmission grating with rectangular grooves, 900 grooves per mm, and a duty cycle of 0.5. The grooves were etched to remove all of the Ta₂O₂ film, thus resulting in a groove depth of 1.4 micron identical to the thickness of the Ta₂O₂ film.

A center wavelength of λc=1550 nm was used for this diffraction grating, and light was applied at an incidence angle of 44 deg from the side with the diffraction grating. The diffraction efficiency was measured in a system where the 1550 nm light had a −1 order diffraction angle of −44 deg. Good characteristics were obtained, as shown in FIG. 5, with the diffraction efficiency for TE mode in a range of approximately 1500-1700 nm and TM mode in a range of approximately 1600-1800 nm being at least 80%, and the PDL being no more than +/−1 dB in the 1550+/−250 nm range.

### Comparative Example

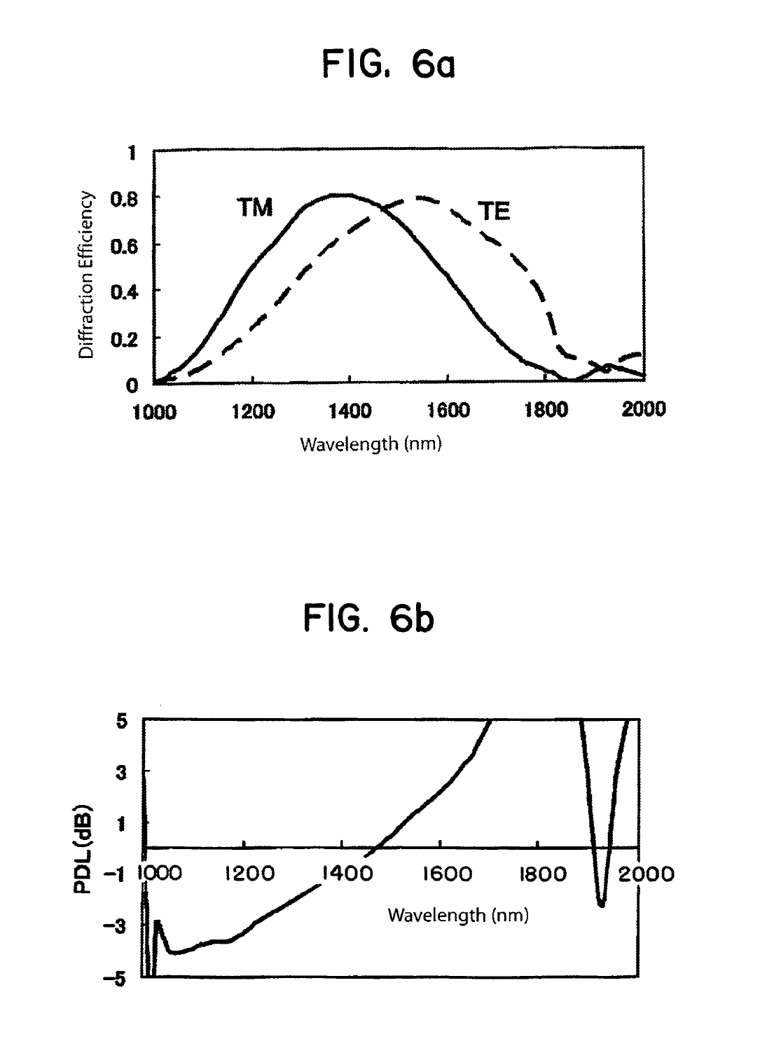

Using a method similar to that of the first embodiment, a transmission grating was formed from a quartz substrate with 939 grooves per mm, a duty cycle of 0.56, and rectangular grooves of 3.9 micron depth. A center wavelength of λc=1550 nm was used for this diffraction grating, and light was applied at an incidence angle of 45 deg from the side with the diffraction grating. The diffraction efficiency was measured in a system where the 1550 nm light had a −1 order diffraction angle of −45 deg. As shown in FIG. 6, the diffraction efficiency for both TE mode and TM mode was no more than 80%, and, because the wavelengths of maximum diffraction efficiency are offset from each other by 150 nm, the range at which PDL is no more than +/−1 dB is limited to a range of 1400-1550 nm

A preferable range for transmission gratings was determined based on all the results shown in Table 1.

TABLE 1

| | Index of | | Average | | | |
|---|---|---|---|---|---|---|
| | refraction | Duty | Index of | | | |
| No. of | N for the | Cycle | Refraction | | Diffraction | Embodi- |
| grooves | material | D | n | PDL | Efficiency | ment |
| 900 | 1.44 | 0.45 | 1.24 | x | x | |
| 939 | 1.45 | 0.56 | 1.20 | x | x | |
| 939 | 1.45 | 0.65 | 1.16 | x | x | |
| 939 | 1.38 | 0.80 | 1.08 | ∘ | ∘ | |
| 800 | 1.44 | 0.70 | 1.13 | ∘ | ∘ | 2 |
| 939 | 1.40 | 0.80 | 1.08 | ∘ | ∘ | |
| 701 | 1.60 | 0.56 | 1.26 | ∘ | ∘ | |
| 939 | 1.42 | 0.80 | 1.08 | ∘ | ∘ | |
| 939 | 1.45 | 0.80 | 1.09 | ∘ | ∘ | 1 |
| 900 | 1.44 | 0.86 | 1.06 | ∘ | ∘ | |
| 939 | 1.45 | 0.90 | 1.05 | ∘ | ∘ | |
| 939 | 1.53 | 0.80 | 1.11 | ∘ | ∘ | |
| 939 | 1.45 | 0.95 | 1.02 | ∘ | ∘ | |
| 900 | 1.94 | 0.50 | 1.47 | ∘ | ∘ | 4 |
| 939 | 1.60 | 0.80 | 1.12 | ∘ | ∘ | |
| 900 | 2.14 | 0.50 | 1.57 | ∘ | ∘ | 3 |
| 939 | 1.80 | 0.80 | 1.16 | ∘ | ∘ | |
| 939 | 2.00 | 0.80 | 1.20 | ∘ | x | |
| 939 | 2.20 | 0.80 | 1.24 | ∘ | x | |

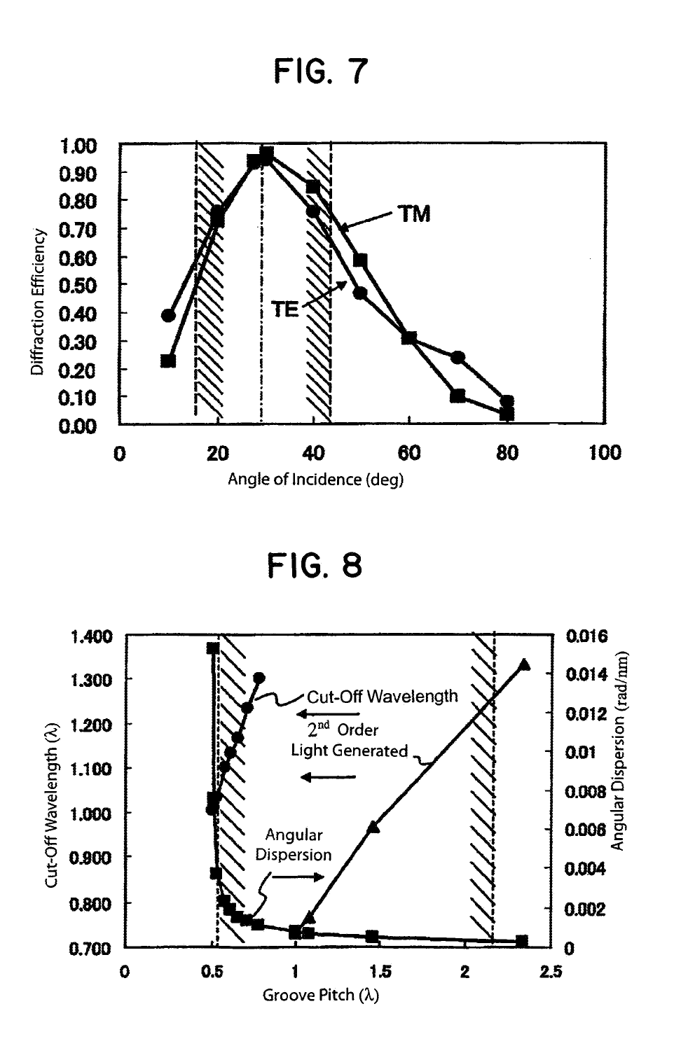

A diffraction grating made with groove pitch a can provide adequate diffraction efficiency even if the wavelength and angle of incidence diverge somewhat from the Bragg condition described above. FIG. 7 shows the diffraction efficiency for 1-order diffraction light as a factor of the angle of incidence at a wavelength of 1500 nm with a transmission grating having 700 grooves per mm, a duty cycle of 0.56, and a groove depth of 2.4 micron. A value of θ=31 deg is the angle of incidence that would meet the Bragg condition, but an acceptable diffraction efficiency of at least 80% can be obtained within a range of +/−10 deg from this angle.

Divergences in the wavelength λ and groove pitch a would also be tolerated within a range that would result in a change in the angle of emergence corresponding to a deviation in the angle of incidence of +/−10 deg from the Bragg condition. These characteristics are generally applicable with the transmission gratings of the present invention. However, the angle of incidence must not exceed 89 deg and the sign of the angle of incidence must not change.

Diffraction gratings with rectangular grooves generally tend to have lower diffraction efficiency for higher orders. As a result, even if the number of grooves is relatively low and the presence of +2 diffracted light or −2 diffracted light is tolerated, to some extent a high diffraction efficiency can be provided for +1 order diffracted light or −1 order diffracted light.

However, in systems that handle +1 order diffracted light or −1 order light as signals, it would be preferable to have conditions where +2 order diffracted light or −2 order diffracted light are not generated so that a high diffraction efficiency is possible for +1 order diffracted light or −1 order light. The advantages of the transmission grating of the present invention can be made more effective by using a groove count that does not generate +2 order light or −2 order light under the Bragg condition described above.

FIG. 8 shows the cut-off wavelengths for +2 order diffracted light or −2 order diffracted light as a factor of groove pitch. The groove pitch and cut-off wavelength are normalized for the center wavelength λc of the wavelength range. If the pitch is shorter than the solid line, no +2 order diffracted light or −2 order diffracted light will be generated. If the groove pitch is 1.48 λc, for an angle of incidence that fulfills the Bragg condition for center wavelength λc, +2 order light and −2 order light will not be generated even with a wavelength of λc-0.013 λc.

For example, at λc=1550 nm, setting the groove pitch to 1.48 λc=2294 nm will result in no +2 order light and −2 order light for wavelengths longer than 1530 nm under the Bragg condition. Thus, this configuration is effective in providing high diffraction efficiency for the entire C band in optical communications.

The shorter the groove pitch is than 1.48 λc, the less +2 order light and −2 order light tends to be generated. As shown in FIG. 8, a groove pitch of 1.1 λc or less is more preferable because a greater angular dispersion is obtained.

For transmission gratings, when the angular dispersion is greater, the diffraction angle can lead to a total internal reflection at the boundary surface between the substrate and the emergence medium. The characteristics of this cut-off wavelength is also shown in FIG. 8. Based on the figure, it would be preferable for the groove pitch to be at least 0.51 λc. For example, at λc=1550 nm, a groove pitch of at least 0.51 λc will allow light with wavelength shorter than 1565 nm to emerge from a standard transparent glass substrate without total internal reflection taking place. This makes it possible to use the diffraction grating of the present invention in the enter C band range for optical communications.

Based on the above, it can be seen that, for a center wavelength of λc for the wavelength range to be used, it would be preferable for the groove pitch a to be in the range of 0.51 λc-1.48 λc. It would be more preferable for the upper limit to be no more than 1.1 λc. By setting the groove pitch in this range, +/−2 order diffracted light can be prevented while a high angular dispersion can be provided and diffracted light can emerge without total internal reflection.

The diffraction efficiency of a diffraction grating is significantly influenced by the shape of the grooves. With transmission gratings, the diffraction efficiency is further influenced by the index of refraction of the material used to form the grooves in the diffraction grating. A high diffraction efficiency can be obtained for transmission gratings by optimizing both the shape of the grooves and the index of refraction of the material used for the grooves.

With transmission gratings, the index of refection of the material forming the periodic structure of the diffraction grating significantly influences the diffraction efficiency. In transmission gratings, a high diffraction efficiency can be obtained by optimizing both the shape of the ridges (grooves) and the index of refraction of the material used.

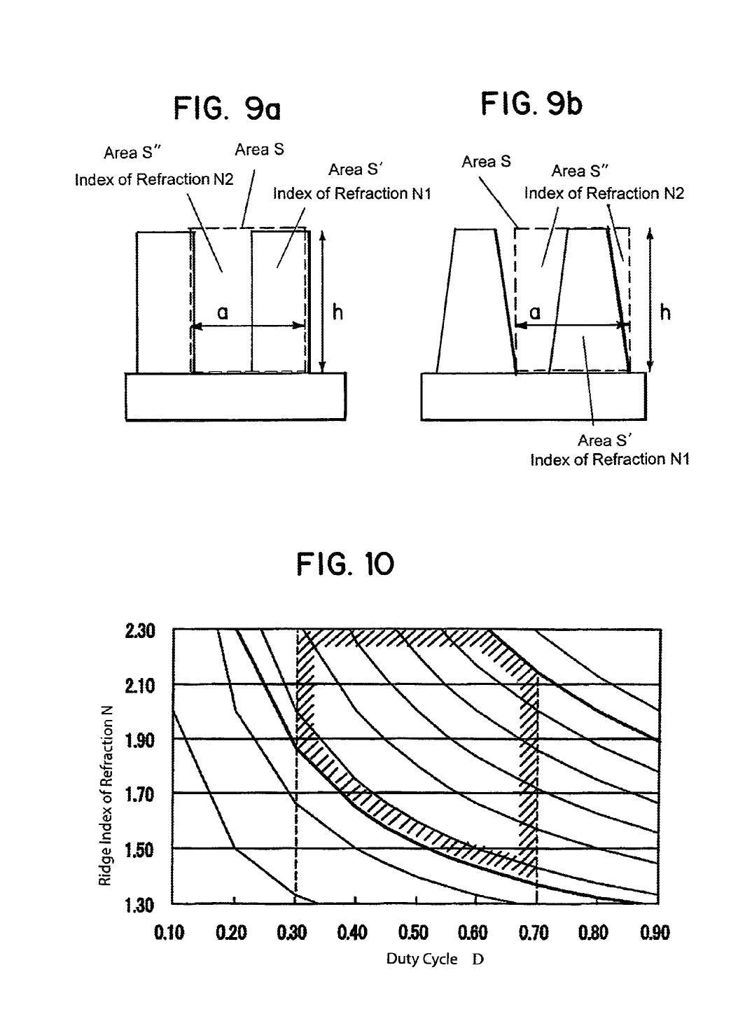

In FIG. 9 (a), there is shown the pitch a of the diffraction grating grooves, the groove width d, and the groove depth h. The cross-sectional area for one period in the periodic structure is S=a×h, and S″ represents the cross-sectional area of the groove and S′ represents the cross-sectional area of the ridge. More specifically, S′=S−S″. The average index of refraction n for the periodic structure of the diffraction grating is represented as:
n=(S′/S)×N1+(S″/S)×N2
(this is referred to in the present invention as the average index of refraction of the periodic structure). N1 is the index of refraction of the ridge and N2 is index of refraction of the groove.

This equation can be rewritten using duty cycle D (=d/a).
n=DN2+(1−D)N1

If the groove is air, N2=1, so this becomes
D(1−N1)+N1=n.

FIG. 10 shows the relationship between N1 (referred to as N) and D with the average index of refraction n as a parameter. Based on the results from Table 1, if the average index of refraction of the periodic structure is at least 1.26, the polarization dependence of the diffraction efficiency can be kept low. Also, if n is at least 1.8, a high diffraction efficiency can be obtained. The two curves indicated by thick lines correspond to the curves for n 1.26 and n=1.8.

Thus, the region between these two curves is preferable. However, to produce a stable periodic structure, it would be preferable for the duty cycle D to be in the range 0.3-0.7. Also, with materials that can be generally used, N<=2.3, so the cross-hatched region in FIG. 10 becomes the preferable region. Representing this in terms of (D, N) coordinates, the region could be indicated as the region bounded by the following coordinate points.

(0.30, 1.87), (0.30, 2.30), (0.62, 2.30),

(0.70, 2.14), (0.70, 1.37), (0.50, 1.52)

(0.40, 1.65)

The ridges in the diffraction grating do not have to be formed solely from one type of material. For example, as shown in FIG. 11 (a), it would be possible to form ridges 32 from multiple types of layered material. In this case, the apparent index of refraction N1′ of the material forming the ridges 32 would be:
N1′=(S1″/S)×n1+(S2″/S)×n2+(S3″/S)×n3+ . . .
Where the indices of refraction for the different materials are n1, n2, n3, . . . , and the cross-sectional areas of the materials are S1″, S2″, S3″, . . . .

It would also be possible, as shown in FIG. 11 (b), for ridges 42 to be formed from alternating layers of a material with a low index of refraction and a material with a high index of refraction. In this case, the apparent index of refraction N1′ would be a value between the low index of refraction and the high index of refraction. In these cases, the apparent index of refraction is treated as the index of refraction N1 of the ridge material and the preferred range in FIG. 10 is set up.

The transmission grating of the present invention is characterized by grooves having rectangular cross-sectional areas as shown in FIG. 9 (a). In cases where dull corners or oblique angles for the side surfaces as shown in FIG. 9 (b) take place during the production process, the advantages of the present invention can still be provided as long as the shapes are essentially rectangular. However, the shape must be taken into account with regard to the average index of refraction described above. In cases such as the one shown in FIG. 9 (b), the cross-sectional area S′ of the ridges are smaller than they would be as rectangles, so the average index of refraction is less.

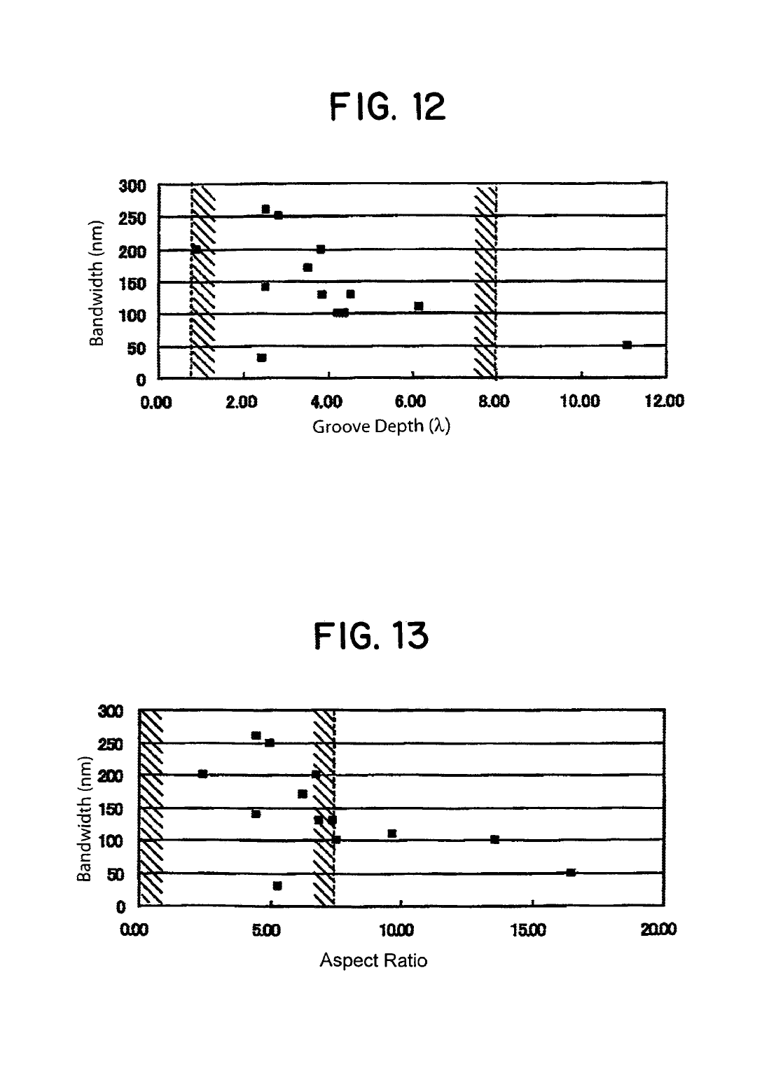

The optical characteristics of transmission gratings are influenced significantly not only by the average index of refraction of the periodic structure but also be the depth h of the grooves. FIG. 12 shows the wavelength range for which a diffraction efficiency of at least 80% can be obtained (this is defined as the bandwidth) relative to the groove depth h for the embodiments. With larger values for h and deeper grooves, the bandwidth tends to narrow, and grooves that are too deep prevent good characteristics from being obtained over wide wavelength ranges. Also, when h is small and the groove depth is too shallow, a high diffraction efficiency cannot be obtained. Thus, it would be preferable for the groove depth h to be 0.8 λc-8 λc.

Taking the production process for the diffraction grating, however, it would be preferable for the groove depth to be shallower since this makes production easier. FIG. 13 shows the relationship between aspect ratio and bandwidth as defined above, where the aspect ratio is the ratio of h/d where h is the groove depth and the d is the groove width. From these results, it would be preferable for the aspect ratio to be no more than 6.8.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A transmission grating comprising:
a plurality of parallel ridges that are transparent at a wavelength range to be used is disposed at a fixed pitch on one surface of a substrate that is transparent at said wavelength range to be used; and
parallel grooves are formed between said ridges,
wherein, when light is applied to said surface on which said grooves of said transmission grating are formed and diffracted light is obtained from a substrate surface on which said grooves are not formed, a groove pitch a is in a range of 0.51 λc-2.16 λc, where λc is a center wavelength of the wavelength range to be used,
a groove period is between 700 nm and 1000 nm, and
a duty cycle D=d/a of the transmission grating is at least 0.45, where d is the width of a groove.

2. A transmission grating according to claim 1 wherein said groove pitch a is in a range 0.51 λc-1.48 λc.

3. A transmission grating according to claim 2 wherein said groove pitch a is in a range 0.51 λc-1.1 λc.

4. A transmission grating comprising:
a plurality of parallel ridges that are transparent at a wavelength range to be used is disposed at a fixed pitch on one surface of a substrate that is transparent at said wavelength range to be used; and
parallel grooves are formed between said ridges,
wherein, when light is applied to said surface on which said grooves of said transmission grating are formed and diffracted light is obtained from a substrate surface on which said grooves are not formed, a groove pitch a is in a range of 0.51 λc-2.16 λc, where λc is a center wavelength of the wavelength range to be used,
a groove period is between 700 nm and 1000 nm, and
an average index of refraction n of a diffraction grating region formed from said ridges and said grooves is in a range of at least one of 1.02-1.16 and 1.26-1.57.

5. A transmission grating according to claim 4 wherein an index of refraction N of said ridges and a ratio D=d/a of a groove width d and a groove pitch a are within a region bounded by points (D, N) indicated below on a D-N plane coordinate system where N is a longitudinal axis and D is a lateral axis:
(0.30, 1.87), (0.30, 2.30), (0.62, 2.30),
(0.70, 2.14), (0.70, 1.37), (0.50, 1.52)
(0.40, 1.65).

6. A transmission grating as described in claim 4 wherein said ridges are formed from at least two different materials.

7. A transmission grating according to claim 1 wherein a depth h of said grooves is in a range 0.8 λc-8.0 λc with regard to said center wavelength λc of said wavelength range to be used.

8. A transmission grating according to claim 7 wherein an aspect ratio h/d defined as a ratio of said groove depth h and a groove width d is no more than 6.8.

9. A transmission grating comprising:
a transparent substrate made from a first material;
a plurality of ridges disposed on the substrate at a fixed width, the plurality of ridges being transparent at a wavelength range to be used; and
a plurality of grooves positioned between each of the plurality of ridges;
wherein, when light is applied to a surface on which the plurality of grooves of the transmission grating are formed and diffracted light is obtained from the substrate surface on which the plurality of grooves are not formed, a groove pitch a is in a range of 0.51 λc-2.16 λc, where λc is a center wavelength of the wavelength range to be used,
a groove period is between 700 nm and 1000 nm, and
a duty cycle D=d/a of the transmission grating is at least 0.45, where d is the width of a groove.

10. A transmission grating according to claim 9, wherein the plurality of ridges is formed from a material having a low index of refraction and a material having a high index of refraction arranged in alternating layers.

11. A transmission grating according to claim 9, wherein each of the plurality of ridges has a substantially rectangular cross-section.

12. A transmission grating according to claim 11, wherein each of the plurality of ridges has tapered corners or obliquely-angled side surfaces.

13. A transmission grating according to claim 11, wherein each of the plurality of ridges has an upper base formed as a spherical shape, and each of the plurality of grooves has a bottom that is formed as a spherical shape.

14. A transmission grating according to claim 9, wherein the ridges are formed by processing the transparent substrate itself.

15. A transmission grating according to claim 9, wherein the ridges comprise a second transparent material deposited and processed on the transparent substrate

16. A transmission grating according to claim 9, wherein an average index of refraction n of the periodic structure is in the range of at least one of 1.02-1.16 and 1.26-1.57.

17. A transmission grating according to claim 16, wherein an index of refraction N of the ridges is less than 2.3.

18. A transmission grating according to claim 9, wherein a depth h of said grooves is in a range 0.8 λc-8.0 λc with regard to the center wavelength λc of the wavelength range to be used.

19. A transmission grating according to claim 18 wherein an aspect ratio h/d defined as a ratio of the groove depth h and a groove width d is less than or equal to 6.8.

20. A transmission grating as described in claim 9 wherein said ridges are formed from at least two different materials having different indices of refraction.
